(19) United States
(12) Patent Application Publication
(10) Pub. No.: US 2006/0085690 A1
(43) Pub. Date: Apr. 20, 2006

(54) Method to chain events in a system event log

(75) Inventors: Austin P. Bolen, Austin, TX (US); Anand Joshi, Round Rock, TX (US); Mukund P. Khatri, Austin, TX (US); Allen C. Wynn, Round Rock, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/966,658

(22) Filed: Oct. 15, 2004

(51) Int. Cl. G06F 11/00

(52) U.S. Cl. 714/39

(57) ABSTRACT

A method and system for recording hardware and software events of a computer system. An event logger, typically part of system management software, records both primary event records and secondary event records. Secondary event records are used when the data space in a primary event record is insufficient to adequately describe the primary event. The data fields of a secondary event record designate the record as a secondary event and contain the additional data about the event.

### TECHNICAL FIELD OF THE INVENTION

This invention relates to computer system management, and more particularly to providing event logs for computer systems.

### BACKGROUND OF THE INVENTION

For computer systems, event logging provides a standard, centralized method for recording software and hardware events. One or more hardware or software components of the system are “event generators”, and generate and send event messages to an “event logger”, which records the events in memory. An “event viewer” provides a user interface for viewing the events. Event data can be further exposed and parsed, using sophisticated application software for event log management.

For an active system, such as a server, the task of generating an event log is not an easy one—even one server can generate thousands of events in a short time interval. For today's servers, events are logged in accordance with an industry-wide standard known as Intelligent Platform Management Interface Specification (IPMI).

IPMI defines the messages and system interface to “intelligent” platform sensors, which are used to monitor the system's physical health characteristics, such as processor and system temperatures, fan speed, and voltage levels. Events can also be generated by software. The IPMI specification establishes standard guidelines for the implementation of a monitoring and alerting subsystem that aims to attain “always available manageability” of server systems.

### SUMMARY OF THE INVENTION

In accordance with teachings of the present disclosure, systems and methods are described for generating and viewing an event log. The invention is especially suitable when the event records that comprise the event log have a predetermined format having limited data space for data describing the event. In accordance with the invention, events are either “primary” or “secondary”. Primary events are recorded using the conventional event record format. Any primary event may be chained to one or more secondary events. The secondary event is identified as such using a data field of the event record. The data field of the secondary event record(s) contain the additional data to describe the event.

In one embodiment of the invention, the event log is recorded in accordance with the IPMI standard. The secondary event record is designated as such in one of the IPMI event record fields, such as in the event type field. The secondary event data field contains the additional data.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a computer system having an event logger in accordance with the invention.

FIG. 2 illustrates an example of an event log with only primary event records.

FIG. 3 illustrates an example of an event log having both primary and secondary event records.

### DETAILED DESCRIPTION OF THE INVENTION

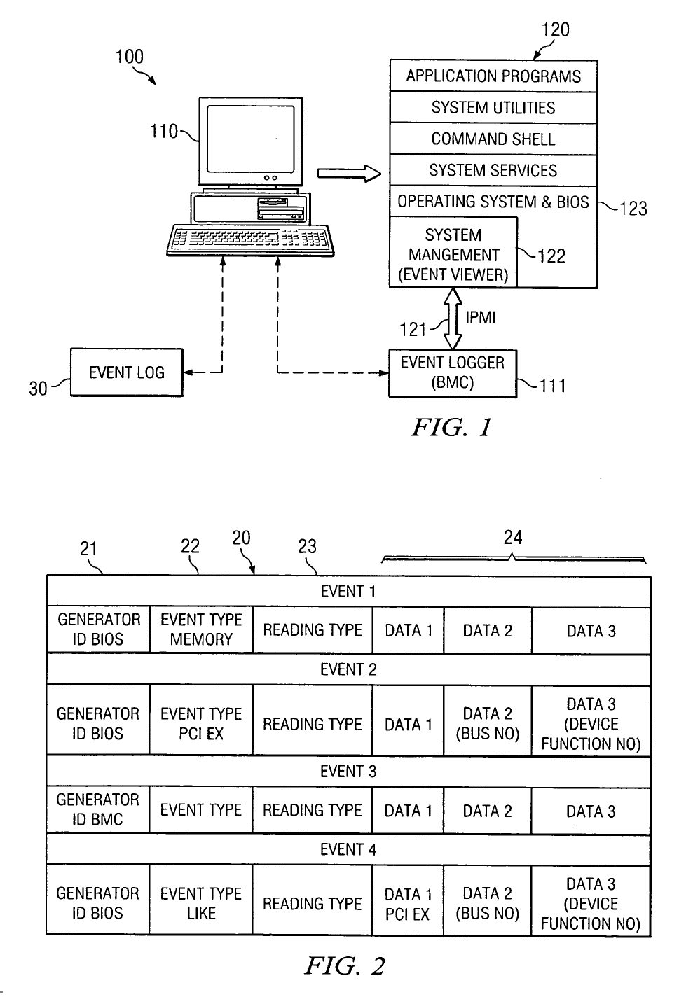

FIG. 1 illustrates a typical computer system 100, which in the example of this description is a server system. The concepts described herein may be applied to any “information handling system” 100 that maintains an “event log” 30.

Thus, in addition to a server system, computer system 100 could be any “information handling system” that is programmable using a high-level computer programming language. The computer system may also be implemented using specially-programmed, special-purpose hardware. In computer system 100, the processor is typically a commercially-available processor, such as those available from the Intel Corporation, Sun Microsystems, or Motorola. The processor usually executes an operating system which may be, for example, those available from the Microsoft Corporation, Apple Computer, Sun Microsystems, Palm, Inc. or other UNIX-based operating systems available from various sources.

An “event log” 30 is defined as a data repository, typically non-volatile memory, for recording system events. It is assumed that the system 100 has an event logging mechanism for recording events (here BMC 111), and an event viewing mechanism (here part of system management software 122) for viewing or otherwise accessing the event log.

Where computer system 100 is a server system, it communicates with one or more client systems (not shown) for the purposes of exchanging information and performing transactions, such as database transactions. These systems communicate using a communication protocol over a network. Server 100 may be, for example, a hypertext transfer protocol (HTTP) server that is configured to perform database transactions. The communication network (not shown) may be an Ethernet network, Fast Ethernet or other type of local or wide area network (LAN or WAN), a point-to-point network provided by telephone services, or other type of communication network or combination of networks. Information consumers and providers, also referred to in the art as client and server systems, respectively, communicate through the network to exchange information.

For the example of FIG. 1, where the system hardware 110 is hardware associated with a server system, the hardware may include a processor connected to one or more storage devices, such as a disk drive, through a communication device, such as a bus. The computer hardware 110 may also include one or more output devices, such as a monitor, printer, or graphic display, or printing device and one or more input devices, such as a keyboard, mouse or other device. The system 110 has memory for storing programs and data during operation of the computer system. In addition, the system 110 may contain one or more communication devices that connect the computer system 100 to a communication network.

A baseboard management controller (BMC) 111, is a microcontroller that manages the interface between system management software 122 and system management hardware. It monitors events, and receives and logs event messages in the event log 30.

The system software 120 comprises applications programs, system utilities, a command shell, system services, the operating system, and the system BIOS. A typical server operating system is Windows, a product of Microsoft Corporation. “BIOS” is an acronym for basic input/output system, and determines what the system 100 can do without accessing programs from a disk. For example, the BIOS contains programming code required to control the keyboard, display screen, disk drives, serial communications, and a number of miscellaneous functions.

The BIOS also operates in conjunction with the BMC 111 to log system events. Events are logged according to the IPMI standard described in the Background. Specifically, the BIOS generates event messages and sends them to the BMC 111, which records them in event log 30.

“System management software” 122 is a generic term used herein to describe whatever software programming provides the event log for viewing, by accessing the event log 30 and parsing event data. The particular task of the system management software 122 that reads the event log and provides a viewable event display is referred to herein as the “event viewer”. In the example of FIG. 1, the event viewer is shown low on the software stack. However, event viewing may be alternatively performed by high level software with sophisticated event management features.

As a hardware level interface, IPMI 121 sits at the bottom of the typical system management software stack. IPMI works independently of the operating system, which permits system administrators to access and recover systems even if the operating system is not responding or if the system is powered down. In other embodiments, an event management interface other than IPMI could be substituted.

FIG. 2 is an example of a portion of an event log 30 generated for viewing by the event viewer 122. Four events have been recorded, thus there are four “event records”. In the example of FIG. 2, all four event records are for primary events.

According to IPMI, each event is recorded with a predefined number of fields of data. The fields and data that are available for viewing are determining by the event logging and viewing software provided as part of the system management software 122. In the example of FIG. 2, the viewed fields are the generator ID 21, event type 22, reading type 23, and three data fields 24.

The generator ID field 21 describes the origin of the event. Examples are ID's for BIOS and BMC 111. If the event was generated from software, this is the software ID.

The event type field 22 contains data that describes the type of trigger for the event. It can also indicate the class of the event, such as “threshold going high”. Examples are memory, processor, critical, OEM, etc.

The event reading type field 23 contains data that indicates a sensor reading status. Examples are threshold, discrete, generic, or OEM specified.

The event data fields 24 are used to provide additional information about the event. Three bytes of data are allocated for event data. The first byte is predefined, leaving only two “free” bytes of data. An exception exists if the user is logged in as an OEM, in which case, there may be more available bits.

For many events, the event data fields 24 are insufficient in size to provide useful information about the event. For example, an event related to the PCI express bus should identify the bus, the device function number, the error registers, and the values in those registers.

As indicated by Events 2 and 4 in the sample event log of FIG. 2, when the event data fields 24 provide only two “free” bytes of data, there is room only for the bus and device function number. This information does not assist in diagnosis of a problem, because it does not provide information about registers and contents.

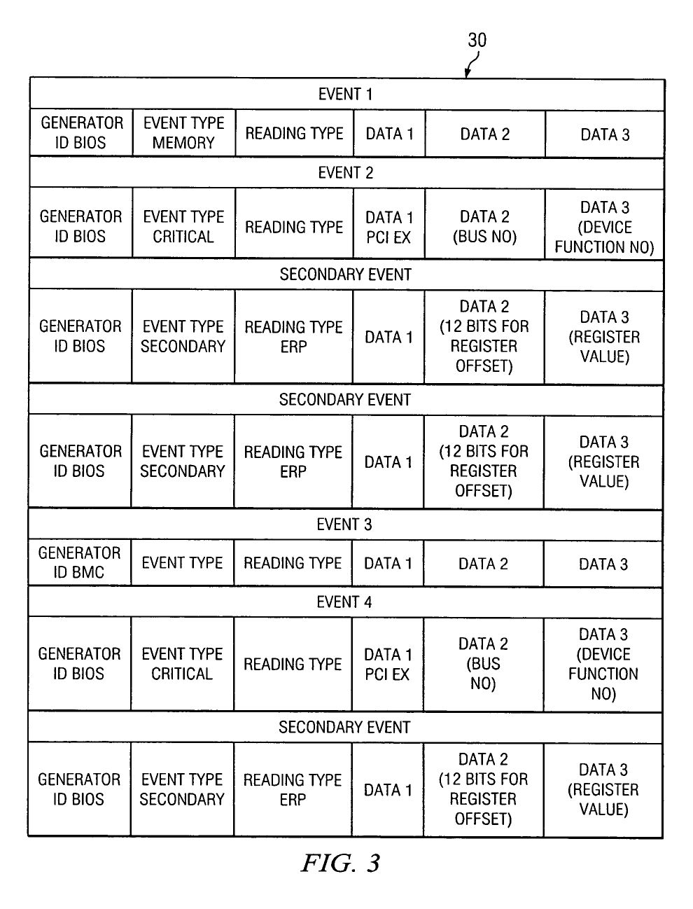

FIG. 3 illustrates an example of an improved event log 30 in accordance with the invention. FIG. 3 illustrates both primary and secondary event records. Conventional methods and formats are used to record primary events. However, as illustrated, after a primary event, one or more secondary event records may be recorded. A secondary event record does not log a “complete” event, but rather, logs additional information about a primary event.

In the example of FIG. 3, Events 1, 2, 3, and 4 are primary events, and correspond to the events of the event log of FIG. 2. Events 2 and 4 have secondary events.

The primary event records describe which device caused the error, and are followed by one or more secondary events. In the example of FIG. 3, the secondary event(s) provide information about a register that contains error values or status data.

Thus, any primary event may be followed in sequence by one or more secondary events. After a primary event, the event logger logs secondary events with the same generator ID as the associated primary event.

To determine the end of the event trail, the event viewer 122 looks for another primary event with the same generator ID. Because concurrent events may be logged in an interleaved manner, another primary event with a different generator ID does not necessarily mark the end of the event trail. Thus, the event trail remains “open” for logging of additional secondary events, until the occurrence of a new primary event from the same event generator.

A value in the event type field 22 identifies the record as a secondary event record. This value is referred to herein as the “secondary event record designator”. In the example of this description, this value is 0xC1 which is from an OEM range of values in the IPMI standard. Other values could be used.

For Events 2 and 4, the event logger 111 has logged the secondary events using a event register pointer (ERP). A value in the event reading type field 23 defines the ERP. In the example of this description, the event reading type is 0x7E from the IPMI OEM range of values, but other values could be used. The ERP maps a 12 bit register offset into the space provided by its primary event. The register space may be of type PCI register, memory, or I/O and is determined by the primary event.

After a primary event, there may be no secondary events or there may be many secondary events. In the event log 30, ERPs appear in sequence after the primary event and have the same generator ID. Another primary event with the same generator ID marks the end of the ERP trail. This ensures that all secondary information is accessed and viewed after the corresponding primary event.

Various types of secondary events may be logged. Events particularly suited for the use of secondary event records are events that define an address space, such as the events related to PCI and PCI Express busses described above. These “address space” events may be implemented with ERPs as described above. Secondary events not related to address spaces, may use other data in the reading type field 23.

What is claimed is:

1. A method of logging events in an event log of a computer system, comprising:
recording a primary event record for each event;
wherein each event record has the same format with predefined fields of data;
recording a secondary event record for one or more of the events, the secondary event being identified as a secondary event by using a predetermined secondary event designator written to one of the event record fields;
wherein events are associated with event generators, each having an generator ID, and wherein secondary events are recorded for a primary event until a new event having the same event generator ID is detected.

2. The method of claim 1, wherein the event record format is in accordance with the IPMI standard.

3. The method of claim 1, wherein the secondary event designator is written to an event type field.

4. The method of claim 1, wherein the recording step is repeated for additional secondary events for the same primary event.

5. The method of claim 1, wherein the event is associated with an address space.

6. The method of claim 5, wherein the secondary event record contains a pointer to the address space.

7. The method of claim 1, wherein the event is associated with a system bus.

8. The method of claim 1, wherein the computer system is a server system.

9. A method of logging address-space events in an event log of a computer system, comprising:
recording a primary event record for each event;
wherein each event record has the same format with predefined fields of data;
recording a secondary event record for one or more of the events;
wherein the recording step is performed such that the secondary event is identified as a secondary event with a predetermined secondary event designator written to one of the event record fields;
and wherein the secondary event record further contains a pointer to an address space associated with the event.

10. The method of claim 9, wherein the computer system is a server system.

11. The method of claim 9, wherein events are associated with event generators, each having an generator ID, and wherein secondary events are recorded for a primary event until a new event having the same event generator ID is detected.

12. A method of logging address-space events in an event log of a computer system complying with the IPMI standard, comprising:
recording a primary event record for each event;
wherein each event record has the IPMI format with predefined fields of data;
recording a secondary event record for one or more of the events;
wherein the recording step is performed such that the secondary event is identified as a secondary event with a predetermined secondary event designator written to one of the event record fields;
and wherein the secondary event record further contains a pointer to an address space associated with the event.

13. The method of claim 12, wherein the secondary event designator is written to the event type field.

14. The method of claim 12, wherein the event is associated with an address space.

15. The method of claim 14, wherein the secondary event record contains a pointer to the address space.

16. The method of claim 15, wherein the pointer is written to the reading type field of the event record.

17. The method of claim 12, wherein events are associated with event generators, each having an generator ID, and wherein secondary events are recorded for a primary event until a new event having the same event generator ID is detected.

18. An information handling system, comprising:
a hardware platform having at least a processor and memory for executing instructions;
an event logger operable to record events associated with the hardware platform;
wherein the event logger records both primary and secondary events, each primary event recorded in an event record field having a predefined format, and each secondary event recorded as an event record after a primary event but prior to any next primary event;
wherein the event logger further records secondary events by designating the event as a secondary event in a predetermined data space of the predefined format.

19. The system of claim 18, wherein the predefined format is the IPMI standard format for event records.

20. The system of claim 18, wherein the event logger further records software events.
